(19) United States
(12) Patent Application Publication
(10) Pub. No.: US 2001/0047257 A1
(43) Pub. Date: Nov. 29, 2001

(54) Noise immune speech recognition method and system

(76) Inventors: Gabriel Artzi, Sherman Oaks, CA (US); Yaron Paz, Tel-Aviv (IL); Yehuda Hershkovits, Kfar-Hanagid (IL)

Correspondence Address: William H. Dippert, Esq., Cowan, Liebowitz and Latman, P.C., 1133 Avenue of the Americas, New York, NY, 10036-6799, US

(21) Appl. No.: 09/768,937

(22) Filed: Jan. 24, 2001

(30) Foreign Application Priority Data
Jan. 24, 2000 (IL) 134201

(51) Int. Cl. G10L 15/12; G10L 15/08

(52) U.S. Cl. 704/239

(57) ABSTRACT

A method of assigning a similarity score representative of a similarity between a first speech signal and a second speech signal. The method includes generating a signal transformation responsive to both the first and second signals, determining a transformation score based on at least one characteristic of the generated transformation and calculating the similarity score as a function of the transformation score.

### FIELD OF THE INVENTION

The present invention relates generally to pattern recognition systems, and in particular, to speech recognition systems which identify speech in a noisy background.

### BACKGROUND OF THE INVENTION

Pattern recognition systems, specifically speech recognition systems, are well known in the art. Such systems receive input signals which represent unknown words, phrases, utterances or other symbols. A signal which represents a single unknown word or phrase is usually isolated from the input signals. The isolated signal is compared to a plurality of model signals which represent known words. The word represented by the model signal which is most similar to the isolated signal is chosen as the interpretation of the isolated signal. Generally, the input signal and the model signals are represented by values of a set of features and the comparison between the signals is performed by comparing the values of the features. Typically, when comparing a signal representing an unknown word to the model signal, each model signal is assigned a similarity score representing the similarity between the signal representing the unknown word and the model signal. The similarity score may receive high values when the signals are similar or may represent a distance which receives low values when the signals are similar. In the rest of the present application scores which represent similar signals are referred to as high similarity scores or best scores. Two compared signals which have a high similarity score are considered similar, while two signals with a low similarity score are considered non-similar.

A received signal representing a specific word is rarely identical to the model signal representing the same specific word. The difference between the received and model signals, referred to herein as degradation, may be larger than the difference between two model signals. Therefore, the recognition system may choose the wrong model signal and thus choose a wrong interpretation for the unknown signal. Some systems that have very high successful interpretation rates when the received signals have a low degradation level, have much lower interpretation rates when the signals have a high degradation level.

The degradation may result from many sources, first of all, from the natural dispersion of human generated speech signals. The degradation is enhanced when the model signals originate from a different individual than the input signals. In speech recognition systems, the degradation is enhanced when the model signals are uttered in a different voice type or pronunciation even by the same individual. Some degradation may result from distortions due to the quality of the apparatus receiving the signals, for example, the precision of signal digitizing apparatus. When dealing with speech signals, the distortions may result from telephone lines and microphones. Another source of degradation is in background noise.

Use of more features and/or more robust features, usually achieves higher successful interpretation rates. However, extracting such features for each input signal is very time consuming and requires using powerful processors.

One known method to overcome the degradation includes estimating the degradation and compensating for the degradation before comparing the features of the received signals to the features of the model signals. The degradation is compensated for by changing the received signals, the features of the received signals and/or the features of the models in the library responsive to the estimate of the degradation. Examples of such methods are described in “Adaptive Noise Canceling for Speech Signals”, by Marvin R. Sambur, IEEE ASSP, Vol. 26, No. 5, October 1978, “Efficient Joint Compensation of Speech for the Effects of Additive Noise and Linear Filtering”, by Richard M. Stern et. al., Proc. of the ICASSP, San Francisco, Calif., March 1992, “Optimum signal processing”, Sophochles Orfanidis, Chapter 7, especially pp. 426-432, McGraw Hill, 1988, “A Recursive Feature Vector Normalization Approach for Robust Speech Recognition in Noise”, Kari Laurila et al, ICASSP 98, “High-accuracy Connected Digit Recognition for Mobile Applications”, Raziel Haimi-Cohen et. al., ICASSP 96, and “Noise compensation for speech recognition in car noise environments”, Ruikang Yang and Petri Haavisto, ICASSP 95, pp. 433-436, the disclosures of which are incorporated herein by reference.

For high recognition rates the estimate of the degradation must be updated continuously. However, continuously estimating the degradation requires use of a powerful processor and is therefore generally difficult to achieve. In addition, in order to properly estimate the degradation some systems include additional microphones or other hardware which is burdensome on the user, and makes the system more complicated and expensive.

### SUMMARY OF THE INVENTION

An aspect of some embodiments of the present invention relates to a method for interpretation of degraded speech signals which is suitable for apparatus with relatively low processing power.

An aspect of some embodiments of the present invention relates to a method for word identification of degraded speech signals without estimating the degradation or using a simplified estimate of the degradation. In some embodiments of the present invention, eliminating the need for estimating the degradation results in substantial reduction in the complexity of the computations required to identify the words represented by the signals.

In an aspect of some embodiments of the present invention, comparing an unidentified signal to a model signal includes generating a transformation which transforms the features which represent one of the signals substantially to the features which represent the other signal. A transformation score indicative of the similarity of the unidentified signal and the model signal is generated based on one or more characteristics of the transformation.

In some embodiments of the invention, the transformation is generated based on the features of both the unidentified signal and of the model signal. Optionally, other data, such as data on the origin and/or degradation of the signals, is not necessary in order to generate the transformation. Specifically, in some embodiments of the present invention, no data on the degradation of the unidentified signal is necessary, not even data which may be extracted from the unidentified signal.

In some embodiments of the present invention, the transformation is generated by adjusting parameters of a model of a specific class of transformations. Optionally, the parameters of the transformation are adjusted so as to bring the model signal (i.e. the representation thereof) closest to the unidentified signal (i.e. the representation thereof). In some embodiments of the present invention, the specific class of transformations degrade signals in accordance with common noise and/or distortion models.

In some embodiments of the present invention, the specific class of transformations comprises the group of affine and/or linear transformations. Alternatively, the specific class of transformations comprises a group of transformations formed of linear, polynomial, analytical and/or continuous functions. Further alternatively, the transformation is generated based on any other suitable group of transformations. The class of transformations is optionally chosen according to the available computational resources of the apparatus performing the signal comparison.

In some embodiments of the present invention, more than one transformation is prepared for the pair of unidentified and model signals. Optionally, parameters are adjusted for a list of candidate transformation models, which represent various degradation effects. In some embodiments of the present invention, the parameters of each of the candidate transformation models in the list are adjusted separately to transform the model signal closest to the unidentified signal. Optionally, the adjusted transformation from the list which transforms the model signal closest to the unidentified signal is chosen as the generated transformation. Alternatively, some or all of the prepared transformations are used in preparing the transformation score. Optionally, each transformation is assigned a different transformation score and a total transformation score comprises a weighted sum of the different scores. In some embodiments of the present invention, the weighted sum gives larger weight to transformations which bring the model signal closer to the unidentified signal.

Alternatively to preparing a plurality of transformations which bring the model signal closest to the unidentified signal, the plurality of transformations may form a chain of transformations which transform the model signal in steps to the unidentified signal.

The transformation score optionally represents the extent to which the signal is altered by the transformation. The extent to which a transformation alters signals is indicative of the similarity between the pair of signals used in generating the transformation. Alternatively or additionally, the transformation score represents the extent to which the generated transformation is similar to common models of noises and/or distortions.

The transformation score may be used in various methods to enhance the identification of unidentified signals. A number of methods in which the transformation score may be used are described in the following paragraphs.

In some embodiments of the present invention, a similarity score summarizes a multi-faceted similarity between the model signal and the unidentified signal. In some embodiments of the invention, the similarity score comprises a weighted sum of the transformation score and a pattern matching score of the signals (examples of which follow). Optionally, the transformation is applied to the features representing the model signal, and the pattern matching score is indicative of the similarity between the transformed features and the features of the unidentified signal. Alternatively or additionally, an inverse of the transformation is applied to the features of the unidentified signal and the pattern matching score is indicative of the similarity between the transformed features and the features of the model signal. Further alternatively or additionally, the pattern matching score is indicative of the difference between the non-transformed features of the signals. Further alternatively or additionally, other related scores are included in the weighted sum forming the similarity score.

In some embodiments of the present invention, as described hereinabove, the extent and/or form of the degradation is not estimated or utilized. In other embodiments, described hereinbelow, the degradation is partially determined or estimated in a manner which optionally does not require large computational resources but is useful in enhancing the performance of some embodiments of the present invention.

In some embodiments of the present invention, an expected degradation transform is prepared for each unidentified signal based on an estimate of the degradation of the unidentified signal. The transformation score is assigned based on the similarity of the generated transformation to the expected transform. Optionally, the estimate of the degradation is constant for an entire interpretation session. The estimate is optionally based on the location at which the signals are generated and/or the apparatus used to receive the signals. In some embodiments of the invention, the estimate is based on a comparison of the identity and/or type of voice of the human generating the unidentified signal and of the human generating the model signal. For example, if the human generating both the signals is the same, the degradation is estimated as very low. If the humans generating the signals are different but have similar voices the degradation is estimated as medium and if the humans generating the signals have totally different voices the degradation is estimated as high. Alternatively or additionally, the estimate of the degradation is based on actual measurements of the degradation which may be updated during the interpretation session.

Alternatively or additionally, the expected degradation transform is based on the actual transformations used on one or more previous signals in a current interpretation session. Optionally, the expected transform comprises a transformation generated for an immediately previous unidentified signal in the interpretation session and the model to which it was matched. Alternatively or additionally, the expected transform comprises an average of the transformations of a predetermined number of previous unidentified signals.

In some embodiments of the present invention, the weight of the transformation score in the similarity score is determined based on the level of degradation and/or the noise level in the received signals. Optionally, when the level of degradation is very low the weight of the transformation score is substantially zero and the similarity score is substantially equal to the pattern matching score. Optionally, the level of degradation is estimated based on the signal-to-noise-ratio (SNR) of the unidentified signal. Alternatively or additionally, the degradation level is based on any other available data on the degradation of the unidentified signal.

Some aspects of the present invention, relate to conserving computational resources. Conserving on computational resources allows performing pattern recognition with smaller and cheaper apparatus and/or enhancing the interpretation rate and the word vocabulary handled by the apparatus.

In some embodiments of the present invention, when data on the actual degradation is used to enhance the performance of the present invention, the degradation data is optionally determined in a manner minimally exploiting the systems computational resources. In some embodiments of the present invention, the degradation of the signals is measured periodically, say once every minute. Alternatively or additionally, the degradation of the signals is measured when excess computational resources are available.

Some pattern recognition systems have a library with a large number of model signals which represent a large vocabulary of words. In some embodiments of the present invention, in order to conserve processing time, identifying the unidentified signal is performed in two or more steps. In a first step, the unidentified signal is compared to substantially all the models in the library using a fast, relatively low quality, comparison method. A group of models similar to the unidentified signal are found in the first step and are compared in a second step to the unidentified signal to find a best matching model. The comparison in the second step optionally includes generating a transformation for the unidentified signal and each of the models as described above.

The comparisons of the first step may be performed using any standard pattern recognition method. The group of similar models optionally includes a predetermined number of most similar models. Alternatively or additionally, the group of similar models includes all the models with similarity scores within a fixed range or ratio from the highest similarity score received by any of the models.

Alternatively or additionally, the comparisons of the first step include generating simple transformations, while in the second step more complex transformations are used.

There is therefore provided in accordance with an embodiment of the present invention, a method of assigning a similarity score representative of the similarity between a first speech signal and a second speech signal, including generating a signal transformation responsive to both the first and second signals, determining a transformation score based on at least one characteristic of the generated transformation, and calculating the similarity score as a function of the transformation score.

Optionally, generating the transformation includes generating a transformation which transforms the first signal to a transformed signal such that a distance between the transformed signal and the second signal is in accordance with a predetermined rule.

Alternatively or additionally, generating the transformation includes generating the transformation such that the transformed signal and the second signal are identical.

Further alternatively or additionally, generating the transformation includes selecting the transformation from a plurality of transformations such that the transformed signal is closest to the second signal.

Further alternatively or additionally, generating the transformation includes selecting the transformation from a plurality of transformations such that the selected transformation is closest to a predetermined transformation. In some embodiments of the present invention, the predetermined transformation includes an identity transformation.

Optionally, the transformation is an affine transformation or a linear transformation.

Optionally, generating the transformation includes setting the coefficients of a given transformation. Optionally, the at least one characteristic includes the coefficients of the given transformation.

Optionally, generating the transformation includes generating a transformation which corresponds to an expected degradation of one of the first and second signals.

Optionally, the transformation score includes a function of the extent to which the transformation changes signals to which it is applied.

Optionally, the similarity score includes a function of the transformation score and of a pattern matching score. Further optionally, the similarity score includes a weighted sum of the transformation score and the pattern matching score. Optionally, the weights of the weighted sum are determined responsive to an estimated degradation level of one of the first or second signals. Alternatively, the weights of the weighted sum are determined responsive to a noise level of one of the first or second signals. Optionally, the weighted sum gives relatively low weight to the transformation score when the estimated degradation level is relatively low.

Optionally, the pattern matching score is based on a comparison of the second signal and a transformed version of the first signal. Alternatively or additionally, the pattern matching score is based on a comparison of the first and second signals.

Optionally, the first and second signals are represented by values of features and generating the transformation includes generating the transformation responsive to the values of the features of both the first and second signals. Optionally, generating the transformation includes generating the transformation without determining a degradation form of either the first or second signals. Optionally, generating the transformation includes generating a plurality of transformations each of which represents a different form of degradation. Optionally, the transformation is an affine transformation.

Optionally, the first and second signals include signals represented in a time domain, in a frequency domain and/or by cepstrums.

Optionally, the first signal includes a model signal from a library of model signals and the second signal includes an input signal. Alternatively, the first signal includes an input signal and the second signal includes a model signal from a library of model signals.

In some embodiments of the present invention, the method includes selecting a subset of the library model signals, and generating the transformation, determining the transformation score and calculating the similarity score are performed for each of the model signals in the subset, and choosing a model signal with a best score.

There is further provided in accordance with an embodiment of the present invention, a method of choosing an interpretation of an input signal from a library of model signals, including selecting a subset of the library model signals, generating a plurality of signal transformations for the model signals in the subset, each model signal having a respective transformation, calculating a similarity score for the input signal with each of the model signals in the subset based on at least one characteristic of the respective transformations, and choosing the model signal with a best score.

Optionally, calculating the similarity scores includes calculating a transformation score based on at least one characteristic of the generated transformations. Alternatively or additionally, calculating the similarity score includes calculating the similarity score based on a pattern matching score and based on the at least one characteristic of the respective transformation.

Optionally, selecting the subset includes selecting substantially all the model signals in the library. Optionally, selecting the subset includes selecting model signals originating from a human who generated the input signal.

Optionally, generating the transformations includes, for each model signal in the subset, generating a transformation responsive to both the input signal and the model signal.

There is further provided in accordance with an embodiment of the present invention, a voice recognition system, including a speech interface which receives unidentified input speech signals, an output unit which provides indication of words represented by the input signals, a memory which stores a plurality of model signals and respective words, and a comparator which determines for an input signal received by the speech interface a word to be provided by the output unit, wherein the word is determined by generating for each of a plurality of model signals a respective transformation based on the model signal and the input signal, calculating a similarity score for each of the model signals based on at least one characteristic of the respective transformations, and choosing the model signal with a best score.

Optionally, the comparator calculates the similarity score for each of the model signals based on at least one characteristic of the respective transformations and based on a respective pattern matching score.

### BRIEF DESCRIPTION OF THE DRAWINGS

The present invention will be understood and appreciated more fully from the following detailed description taken in conjunction with the accompanying drawings in which:

FIG. 1 is a schematic block diagram of a speech recognition system, in accordance with an embodiment of the present invention;

FIG. 2 is a schematic illustration of a feature set representing a speech signal, in accordance with an embodiment of the present invention; and

FIG. 3 is a flow chart representation of a method of pattern recognition, in accordance with an embodiment of the present invention.

### DETAILED DESCRIPTION OF EMBODIMENTS

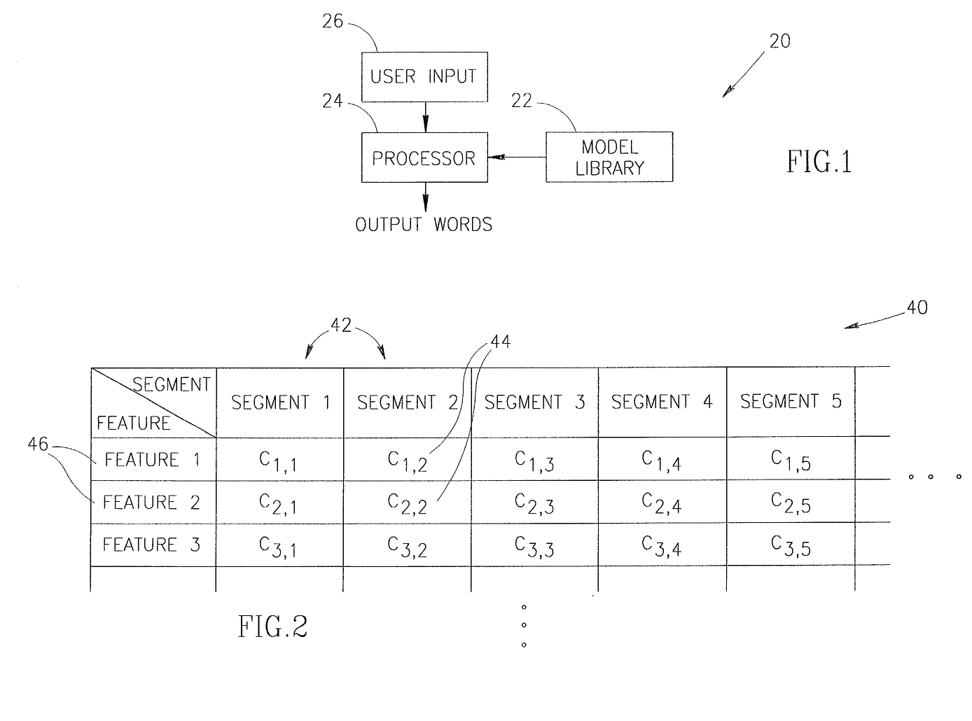

FIG. 1 is a schematic block diagram of a speech recognition system 20, in accordance with an embodiment of the present invention. System 20 comprises a user input 26 such as a microphone or a network interface (e.g., an interface to the Internet), which receives unidentified signals from a user. A processor 24 recognizes the unidentified input speech signals using a model library 22 which includes a plurality of pairs of model speech signals and word descriptors (e.g. word IDs or text strings) which the model signals represent. In the specification and claims of the present application, the term word is to be taken to mean a word, a phrase of one or more words and/or and other sound related symbols.

Optionally, the model signals are generated by a user of system 20. Alternatively or additionally, some or all of the model signals are generated by a professional human speaker with a clear voice. Further alternatively or additionally, the model signals are generated by a plurality of speakers and library 22 optionally stores for each model information on an identity or voice type of a human who generated the model. This information is optionally used in recognizing the unknown signals as described hereinbelow. Model library 22 is optionally stored in a non-volatile memory, such as a FLASH memory, although any other suitable memory may be used. Optionally, the model speech signals in library 22 are represented by sets of features. Alternatively, the model signals are represented by signals in a time domain and/or by signals in a frequency domain or by any other suitable representation.

FIG. 2 is a schematic illustration of a feature set 40 representing a speech signal, in accordance with an embodiment of the present invention. Optionally, the speech signal is divided into segments, and the signal of each segment is represented by a vector 42 of feature values 44. Optionally, the segments have fixed period lengths and therefore the number of vectors 42 representing a specific signal is dependent on the total length of the signal. The fixed period length of the segments is optionally of a length between 10 and 40 msec. Each vector 42 optionally includes values of a plurality of features 46. Optionally, the features 46 include between 8-12 cepstrum coefficients described, for example, in “Fundamentals of speech recognition” by Lawrence Rabiner and Biing-Hwang Juang, Prentice hall 1993, pages 112-116 and 163-170, the disclosure of which is incorporated herein by reference. Alternatively or additionally, the features include delta cepstrums or LPC features. It is noted that feature set 40 is one manner of representing speech signals, and that substantially any other representation manner of speech signals may be used with the present invention.

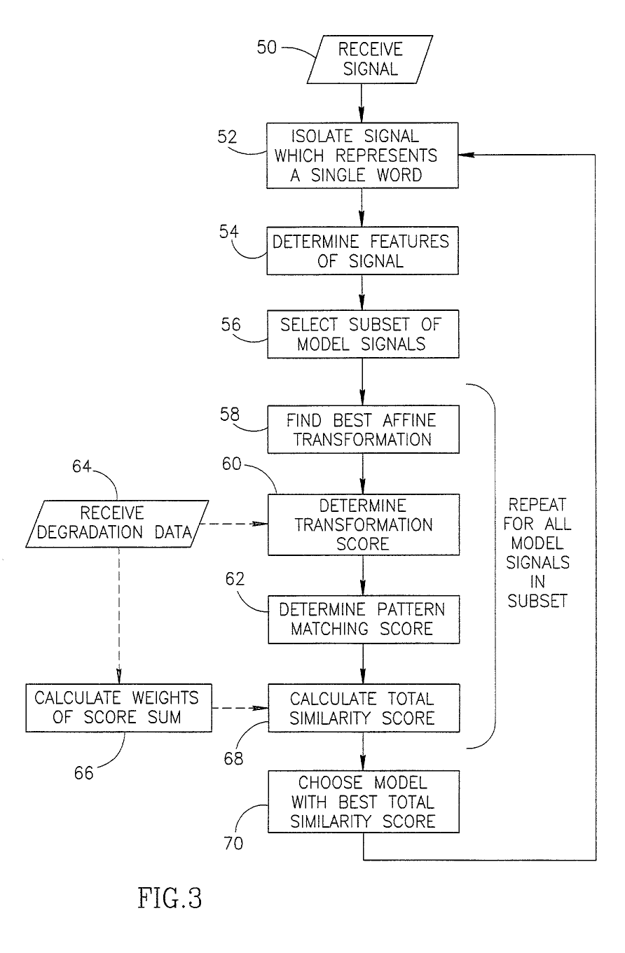

FIG. 3 is a flow chart representation of a method of pattern recognition performed by processor 24, in accordance with an embodiment of the present invention. Processor 24 receives a stream of speech signals (50), for example, a telephone number to be dialed automatically. Processor 24 isolates (52) from the stream a single speech signal (referred to herein as an input signal) which represents an unknown word. Processor 24 isolates the speech signal using any method known in the art, for example, as described in U.S. Pat. No. 5,305,422 to Jonqua or U.S. Pat. No. 5,528,725 to Hui, the disclosures of which are incorporated herein by reference. Alternatively, the stream comprises a single speech signal, for example, representing a command and there is no need to isolate a signal from the stream.

In some embodiments of the invention, processor 24 processes (54) the input signal to determine a set of features 40 which is compatible with the representation of speech signals in library 22. In an embodiment of the present invention, for substantially each model signal, processor 24 prepares a form of the input signal which is of the same length as the model signal using a suitable algorithm, such as the dynamic time warping (DTW) algorithm. Thus, the form of the input signal and of the model signal are of the same length and are represented by the same number of features. Alternatively or additionally, the model signals are brought to the length of the input signal using the DTW algorithm or another suitable algorithm.

Thereafter, a subset of model signals from library 22 are selected (56) as candidates which most similarly match the input signal. Methods of choosing the models in the subset are described further hereinbelow.

In some embodiments of the invention, for each model in the subset, processor 24 generates (58) a transformation which best transforms the model towards the input signal. Optionally, the transformation comprises an affine transformation as described by equation (1) in which ({double overscore (α)}),({double overscore (β)}) are coefficient matrices. It has been found that when the signals are represented by cepstrum features, the affine transformation serves as a relatively accurate model of the effect of environmental noise commonly incident on input signals. Processor 24 sets the coefficients of the transformation according to the features of the specific pair of model and input signals, for example, as described hereinbelow.

$$( \begin{matrix}{C}_{1 , 1}^{tr} & & {C}_{1 , n}^{tr} \\ & ⋰ & \\ {C}_{j , 1}^{tr} & & {C}_{j , n}^{tr}\end{matrix} ) = ( {α}^{\overline{\_}} ) ( \begin{matrix}{C}_{1 , 1} & & {C}_{1 , {n}^{′}} \\ & ⋰ & \\ {C}_{j , 1} & & {C}_{j , {n}^{′}}\end{matrix} ) + ( {β}^{\overline{\_}} ) \qquad ( 1 )$$

In some embodiments of the invention, as described above, the input signal and the model signals are brought to the same length and therefore n=n′ and ({double overscore (α)}) is a square matrix. In some embodiments of the present invention, the features C_{j,m} (for m=1 . . . n) are assumed to be non correlated with respect to each other and therefore ({double overscore (α)}) comprises a diagonal matrix. Thus equation (1) may be written:

C_{j,m}^{tr}=a(j)*C_{j,m}+β(j) (1′)

in which, C_{j,m} is the value of the j-th feature of the m-th segment of the non-transformed signal and C_{j,m}^{tr} is the value of the j-th feature of the m-th segment of the transformed signal. α(j) and β(j) are the coefficients of feature j. Alternatively, the values of α and β of different features are correlated.

Coefficients α and β are optionally chosen such that when the transformation is applied to the model signal the resultant transformed signal is at a minimal distance from the input signal, using any suitable distance definition. Suitable distance definitions include the Itakura distance described, for example, in the above mentioned book, “Optimum signal processing”, pp. 262-264, the Mahalanobis distance, which is described on page 35 of “Neural networks for pattern recognition”, by C. M. Bishop, Clarendon press, 1997, the disclosure of which is incorporated herein by reference, and the mean square error distance. Alternatively or additionally, a weighted distance may be used which gives more and/or less weight to specific features.

For example, using equation (1′) in which the features C_{j,m} are assumed to be non-correlated, and using the mean square error distance definition in adjusting the coefficients, α and β are calculated as described in equations (2) and (3) respectively:

$$\begin{matrix}α ( j ) = \frac{{\sum }_{m = 1}^{N} ( {C}_{j , m}^{input} - E [ {C}_{j , m}^{input} ] ) ( {C}_{j , m}^{model} - E [ {C}_{j , m}^{model} ] )}{{\sum }_{m = 1}^{N} {( {C}_{j , m}^{model} - E [ {C}_{j , m}^{model} ] )}^{2}} & ( 2 ) \\ β ( j ) = \frac{1}{N} {\sum }_{m = 1}^{N} ( {C}_{j , m}^{input} - α ( j ) {C}_{j , m}^{model} ) & ( 3 )\end{matrix}$$

where {C_{j,m}^{input}} is the set of features of the input signal, {C_{j,m}^{model}} is the set of features of the model signal, N is the number of segments in the model and input signals, and E[C_{j,m}] is the expectancy of the j-th feature over the segments of the signal having features C_{j,m}, as defined, for example, by equation (4):

$$E [ {C}_{j , m} ] = \frac{1}{N} {\sum }_{i = 1}^{N} ( {C}_{j , i} ) \qquad ( 4 )$$

Thereafter, processor 24 optionally determines (60) a transformation score TS which represents the amount of change incurred by the transformation. In some embodiments of the invention, the transformation score TS is as defined by equation (5) which measures a distance of the transformation from the identity transformation in which α=1 and β=0:

$$TS ( α , β ) = {\sum }_{j} \{ {( 1 - α ( j ) )}^{2} + {β ( j )}^{2} \} \qquad ( 5 )$$

Alternatively or additionally, the transformation score is calculated in accordance with any other suitable scheme. Several such schemes are described hereinbelow.

In some embodiments of the invention, processor 24 calculates (62) a pattern matching score which represents a difference between a form of the model signal and a form of the input signal. In some embodiments of the invention, the transformation is applied to the model signal, and the pattern matching score represents the difference between the transformed model signal and the original input signal. Alternatively, the transformation is inversed and applied to the input signal, and the pattern matching score represents the difference between the transformed input signal and the original model signal. Alternatively, the pattern matching score represents the difference between the original model signal and the original input signal. In some embodiments of the present invention, the pattern matching score is due to more than one comparison between different forms of the model signal and the input signal.

In some embodiments of the invention, the pattern matching score is calculated using any suitable pattern recognition method compatible with feature set 40 used to represent the speech signals. An exemplary pattern recognition method is described in U.S. Pat. No. 5,809,465 to Ilan et al., the disclosure of which is incorporated herein by reference. Alternatively, the pattern recognition method comprises a one-to-one comparison, as is known in the art. In some embodiments of the present invention, a plurality of pattern recognition methods are used in parallel for the same signals, and the pattern matching score comprises a weighted sum of scores from the pattern recognition methods. A total similarity score of the model signal and the input signal is optionally calculated (68) as a weighted sum of the pattern matching score and the transformation score.

The steps of generating the transformation and determining a total similarity score are optionally repeated for each of the model signals in the subset. The model signal with the highest total similarity score is optionally chosen (70) as the interpretation of the input signal. Alternatively, a smaller group of models having the highest scores is chosen from the subset using a simple test and the interpretation is chosen from the smaller group using more complex methods. Such complex methods may use stronger features, more detailed transformations, better pattern recognition methods, precise degradation modeling as described hereinbelow, etc.

It is noted that the generation (58) of a best affine transformation, for example, requires much less processing resources than estimating the degradation of a signal which represents a single word. Generally, estimating the degradation may require processing power more than a hundred times greater than required for generating a best affine transformation using, for example, a noise spectral subtraction method. Therefore, for a subset of, for example, twenty model signals, the method of FIG. 3 is less processing-power intensive than methods of the art which require estimation of the degradation of the input signal.

Referring back to the step of selecting the subset (56), when library 22 includes a relatively small number of words, for example, less than ten words, the subset optionally includes all the model signals in library 22. Alternatively, the input signal is compared to those model signals which are of substantially the same length as the input signal. Alternatively or additionally, the subset includes those model signals which were generated by the same human as the input signal or were generated by a human with a similar voice type as of the human generating the input signal. Further alternatively or additionally, in order to select the subset, the input signal is compared to substantially all the model signals in library 22 using a fast pattern recognition method. Suitable pattern recognition methods are described, for example, in the above mentioned U.S. Pat. No. 5,809,465. Alternatively or additionally, a faster variation of the method described herein is used to select the subset. For example, in selecting the subset, the method described herein may be applied with a reduced transformation class and/or a simplified transformation and pattern matching scores.

When the subset is formed based on a pattern recognition method, the subset optionally comprises a predetermined number of model signals which most closely resemble the input signal. Alternatively, the subset includes model signals which achieve a pattern matching score within a predetermined range or ratio from a highest score achieved by any of the model signals in the library. Optionally, if only one model is included in the subset, that model is immediately chosen as the correct interpretation of the input signal, and no further processing is performed.

Referring back to the steps of generating (58) the transformation and determining (60) the transformation score, in some embodiments of the present invention, the transformation comprises a linear transformation. Alternatively, the transformation comprises a non-linear transformation, such as a polynomial transformation of a suitable power. Optionally, the user may choose the type of transformation used.

In some embodiments of the present invention, the transformation score TS represents the extent to which the generated transformation differs from an expected degradation transform. Optionally, the expected transform represents an ideal transform which would be identical to the generated transformation in the absence of unexpected noise, given known differences between the model signals and the input signal. For example, the expected transform may represent the difference between two signals representing the same word which are acquired from different speakers or using different apparatus.

In some embodiments of the present invention, the expected transform is constructed based on an estimate of the degradation of the input signal. In some embodiments of the invention, along with receiving (50) the stream of speech signals, processor 24 receives (64) degradation data on the possible degradation affecting the stream of signals. Alternatively or additionally, processor 24 generates the degradation data from the received signals and/or from other input related to the stream of signals. Possibly, the generation of degradation data requires much less processing resources than estimating the degradation. Optionally, the estimate of the degradation is based on a comparison between the nature of the apparatus (microphones, communication lines) used to receive the input and model signals, and/or on a comparison between the identity, accent and/or type of voice of the speakers generating the input and model signals. In some embodiments of the invention, the estimate is based on an expected level of background noise of the input signals.

In some embodiments of the present invention, each model signal in library 22 is accompanied by acquisition data describing, for example, the speaker who generated the model signal and/or the apparatus used to receive the model signal and/or the level of background noise in the model signal. The expected transform of a pair of model and input signals is determined based on a comparison between the acquisition data of the signals. For example, a transform representing a low degradation level is expected when the acquisition data of the model signal and the input signal are similar.

Alternatively or additionally to assigning the transformation score according to the expected transform, the expected transform (or its inverse) is applied to the input signal (or model signal) to form an altered signal which takes into account the expected degradation. In this alternative, the transformation is generated (58) so as to best transform the model signal towards the altered input signal.

In some embodiments of the present invention, the estimate of the degradation is fixed for the entire input stream. In some embodiments of the present invention, the degradation estimate is constructed based on data received from the user. Alternatively or additionally, the estimate is changed for different parts of the input stream. Optionally, processor 24 periodically estimates the actual degradation in a specific input signal as described, for example, in “Environmental Robustness in Automatic Speech Recognition”, by R. M. Stern, ICASSP 1990, and “Robust Speech Recognition by Normalization of the Acoustic Space”, by R. M. Stern, ICASSP 1991, the disclosures of which are incorporated herein by reference. Alternatively or additionally, the actual degradation is estimated when processor 24 is relatively idle.

In some embodiments of the present invention, the expected degradation transform is constructed based on the transformations generated for one or more preceding input signals in the stream of input signals. Optionally, the expected degradation transform is constructed based on the transformations between the input signals and the model signals chosen as their interpretations. Optionally, the expected transform comprises the transformation of the most recent preceding input signal. Alternatively, the expected transform comprises an average of the transformations generated for a plurality of preceding input signals.

Referring back to the step of calculating (68) the total similarity score, in some embodiments of the present invention, the total similarity score comprises a weighted sum of the pattern matching score and the transformation score. Optionally, the weights of the sum are determined (66) based on an estimate of the degradation level of the input signals. When the input signals have a low estimated degradation level, the transformation score is optionally given a low weight and the pattern matching score is given a high weight. Conversely, when the input signals have a high estimated degradation level, the transformation score is optionally given a high weight and the pattern matching score is given a low weight. The dependence of the weights on the degradation level may be in the form of a step function, a linear function or a non-linear function. In addition, the weights may depend on other parameters besides the degradation level. Alternatively or additionally, the weights of the sum depend on the level of the pattern matching score. When the pattern matching score indicates a relatively high similarity, the transformation score is optionally given a low weight.

In some embodiments of the present invention, a plurality of transformations representing different sources of degradation, for example, different characteristics of background noise, are generated for each pair of model and input signal. Optionally, the plurality of transformations are generated such that when the transformations are superimposed they substantially transform the model signal to the input signal. Optionally, a score is assigned to each of the plurality of the transformations according to its similarity to an expected degradation transform representing its respective degradation. The transformation score is optionally a weighted sum of the scores of the plurality of transformations.

It is noted that although the above described embodiments relate to generating transformations which transform the model signals toward the input signal, the present invention includes embodiments in which some or all of the transformations are generated so as to transform the input signal toward the model signal.

It will be appreciated that the above described apparatus and methods may be varied in many ways, including, performing a plurality of steps concurrently and/or charging the order of steps. For example in the method of FIG. 3, the determining (62) of the pattern matching score may be performed concurrently with, before or after finding (58) the best affine transformation and/or determining (60) the transformation score. In addition, a multiplicity of various features and methods have been described. It should be appreciated that different features and/or methods from different embodiments may be combined in different ways. in particular, not all the features shown above in a particular embodiment are necessary in every similar embodiment of the invention. Further, combinations of the above features and methods are also considered to be within the scope of some embodiments of the invention. It should also be appreciated that although some of the embodiments were described only as methods, apparatus for carrying out the methods are within the scope of the invention.

It is noted that the above described embodiments are brought by way of example, and the scope of the invention is limited only by the claims. When used in the following claims, the terms “comprise”, “includes”, “have” and their conjugates mean “including but not limited to”.

1. A method of assigning a similarity score representative of a similarity between a first speech signal and a second speech signal, comprising:
generating a signal transformation responsive to both the first and second signals;
determining a transformation score based on at least one characteristic of the generated transformation; and
calculating the similarity score as a function of the transformation score.

2. The method of claim 1, wherein generating the transformation comprises generating a transformation which transforms the first signal to a transformed signal such that a distance between the transformed signal and the second signal is in accordance with a predetermined rule.

3. The method of claim 2, wherein generating the transformation comprises generating a transformation such that the transformed signal and the second signal are identical.

4. The method of claim 2, wherein generating the transformation comprises selecting the transformation from a plurality of transformations such that the transformed signal is closest to the second signal.

5. The method of claim 1, wherein generating the transformation comprises selecting the transformation from a plurality of transformations such that the selected transformation is closest to a predetermined transformation.

6. The method of claim 5, wherein the predetermined transformation comprises an identity transformation.

7. The method of claim 1, wherein the transformation is an affine transformation.

8. The method of claim 1, wherein the transformation is a linear transformation.

9. The method of claim 1, wherein generating the transformation comprises setting the coefficients of a given transformation.

10. The method of claim 9, wherein the at least one characteristic comprises the coefficients of the given transformation.

11. The method of claim 1, wherein generating the transformation comprises generating a transformation which corresponds to an expected degradation of one of the first or second signals.

12. The method of claim 1, wherein the transformation score comprises a function of an extent to which the transformation changes signals to which it is applied.

13. The method of claim 1, wherein the similarity score comprises a function of the transformation score and of a pattern matching score.

14. The method of claim 13, wherein the similarity score comprises a weighted sum of the transformation score and the pattern matching score.

15. The method of claim 14, wherein the weights of the weighted sum are determined responsive to an estimated degradation level of one of the first or second signals.

16. The method of claim 15, wherein the weighted sum gives relatively low weight to the transformation score when the estimated degradation level is relatively low.

17. The method of claim 14, wherein the weights of the weighted sum are determined responsive to a noise level of one of the first or second signals.

18. The method of claim 13, wherein the pattern matching score is based on a comparison of the second signal and a transformed version of the first signal.

19. The method of claim 13, wherein the pattern matching score is based on a comparison of the first and second signals.

20. The method of claim 1, wherein the first and second signals are represented by values of features and wherein generating the transformation comprises generating the transformation responsive to the values of the features of both the first and second signals.

21. The method of claim 1, wherein generating the transformation comprises generating the transformation without determining a degradation form of either the first or second signal.

22. The method of claim 1, wherein generating the transformation comprises generating a plurality of transformations each of which represents a different form of degradation.

23. The method of claim 1, wherein the first and second signals comprise signals represented in a time domain.

24. The method of claim 1, wherein the first and second signals comprise signals represented in a frequency domain.

25. The method of claim 1, wherein the first and second signals comprise signals represented by cepstrums.

26. The method of claim 1, wherein the first signal comprises a model signal from a library of model signals and the second signal comprises an input signal.

27. The method of claim 1, wherein the first signal comprises an input signal and the second signal comprises a model signal from a library of model signals.

28. The method of claim 27, comprising selecting a subset of the model signals of the library, and wherein generating the transformation, determining the transformation score and calculating the similarity score are performed for each of the model signals in the subset, and comprising choosing a model signal with a best score.

29. A method of choosing an interpretation of an input signal from a library of model signals, comprising:
selecting a subset of the model signals of the library;
generating a plurality of signal transformations for the model signals in the subset, each model signal having a respective transformation;
calculating a similarity score for the input signal with each of the model signals in the subset, based on at least one characteristic of the respective transformations; and
choosing a model signal with a best score.

30. The method of claim 29, wherein calculating the similarity score comprises calculating a transformation score based on the at least one characteristic of the respective transformation.

31. The method of claim 29, wherein calculating the similarity score comprises calculating the similarity score based on a pattern matching score and based on the at least one characteristic of the respective transformation.

32. The method of claim 29, wherein selecting the subset comprises selecting substantially all the model signals in the library.

33. The method of claim 29, wherein selecting the subset comprises selecting model signals originating from a human who generated the input signal.

34. The method of claim 29, wherein generating the transformation for each model signal in the subset comprises generating a transformation responsive to both the input signal and the model signal.

35. A voice recognition system, comprising:
a speech interface which receives unidentified input speech signals;
an output unit which provides indications of words represented by the input signals;
a memory which stores a plurality of model signals and respective words; and
a comparator which determines for an input signal received by the speech interface a word to be provided by the output unit, wherein the word is determined by generating for each of a plurality of model signals a respective transformation based on the model signal and the input signal, calculating a similarity score for each of the model signals based on at least one characteristic of the respective transformations and choosing a model signal with a best score.

36. The system of claim 35, wherein the comparator calculates the similarity score for each of the model signals based on the at least one characteristic of the respective transformations and based on a respective pattern matching score.

37. The system of claim 35, wherein the system does not include apparatus used primarily for degradation estimation.
